(19) United States
(12) Patent Application Publication
(10) Pub. No.: US 2025/0051144 A1
(43) Pub. Date: Feb. 13, 2025

(54) REMOTE CONNECTION MECHANISM FOR LIFT AND TRANSPORT ASSEMBLY

(71) Applicant: KONECRANES GLOBAL CORPORATION, Hyvinkää (FI)

(72) Inventors: Kyle PUISTO, Oconomowoc, WI (US); Eddie RODRIGUEZ, Greenfield, WI (US)

(21) Appl. No.: 18/718,091

(22) PCT Filed: Dec. 10, 2021
(86) PCT No.: PCT/US2021/062849

§ 371 Date: Jun. 10, 2024

(51) Int. Cl. B66C 1/66

(52) U.S. Cl. CPC B66C 1/66

(57) ABSTRACT

An attachment mechanism is configured to receive a connector member including a connector opening. The attachment mechanism includes a housing, an actuator mechanism, and a plate. The housing defines a cavity which selectively receives the connector member. The actuator mechanism includes a lock member movable between an extended position, in which a portion of the lock member extends into the cavity, and a retracted position. The plate is movably mounted in the cavity and movable between a first position, in which the plate prevents the lock member from moving to the extended position, and a second position, in which the plate allows the lock member to move to the extended position. When the connector member is received in the cavity, the plate is moved from the first position to the second position and the lock member is at least partially received by the connector opening.

### FIELD OF INVENTION

The present invention relates to lifting and transporting of loads. Specifically, the present invention relates to lifting and transporting bulkheads.

### BACKGROUND

River locks are important infrastructure in waterway navigation. However, river locks are underwater for most of the time which can cause wear and damage. To address existing damage and prevent additional damage, river locks periodically undergo a dewatering process, where water is removed from the area surrounding the river lock, allowing technicians to inspect, repair, and perform maintenance on the river lock structure. In order to accomplish this dewatering process, bulkheads are commonly used in river locks to partition spaces and block fluid flow between areas, sometimes up to 80 feet underwater. Generally, cranes are used to transport the bulkheads from a storage area to a bulkhead slot and underwater divers facilitate the process by helping to position the bulkheads as well as remove or attach crane cables. The underwater environment provides low visibility to the divers, is unsafe and requires the use of purely mechanical connections. There is a need for safer and more efficient lift and transport systems that can be used in an underwater environment.

### SUMMARY

In one aspect, the disclosure provides an attachment mechanism configured to receive a connector member including a connector opening, the attachment mechanism including a housing, an actuator mechanism, and a plate. The housing defines a cavity which selectively receives the connector member. The actuator mechanism includes a lock member movable between an extended position, in which a portion of the lock member extends into the cavity, and a retracted position, in which the lock member is positioned outside the cavity. The plate is movably mounted in the cavity and movable between a first position, in which the plate prevents the lock member from moving to the extended position, and a second position, in which the plate allows the lock member to move to the extended position. When the connector member is received in the cavity, the plate is moved from the first position to the second position and the lock member is at least partially received by the connector opening.

In another independent aspect, the disclosure provides a remote connection system configured to remotely couple a beam assembly to a load. The load includes a connector member with a connection opening. The remote connection system includes an attachment mechanism coupled to the beam assembly for selectively receiving the connector member. The attachment mechanism includes a lock member movable between a first position, in which the lock member is received in the connection opening, and a second position, in which the lock member is removed from the connection opening. The remote connection system further includes an extended line and a remote actuator. The extended line includes a first end and a second end, and the first end is coupled to the lock member. The remote actuator is coupled to the second end of the extended line for selectively applying tension to the extended line to move the lock member to the second position.

In another independent aspect, the disclosure provides a transportation system for transporting a load. The system includes a lifting machine, a beam assembly, and a remote connection system. The beam assembly includes an upper beam, a rigging, and a lower beam, the upper beam coupled to the lifting machine. The remote connection system includes an attachment mechanism coupled to the lower beam, the attachment mechanism including a lock member movable to selectively engage the load to couple the beam assembly to the load for transportation, and a remote actuator spaced from the beam assembly for operating the attachment mechanism.

Other aspects of the invention will become apparent by consideration of the detailed description and accompanying drawings.

### BRIEF DESCRIPTION OF THE DRAWINGS

FIG. 1 is a perspective view of a transportation system including a lifting machine, a beam assembly, and a remote connection system.

FIG. 2 is a perspective view of the beam assembly of the transportation system of FIG. 1 and a load.

FIG. 2A is a perspective view of an attachment mechanism of the remote connection system of FIG. 1.

FIG. 3 is a perspective section view of the attachment mechanism shown in FIG. 2A in a first configuration.

FIG. 4 is a perspective section view of the attachment mechanism of FIG. 3 in a second configuration.

FIG. 5 is a perspective section view of the attachment mechanism of FIG. 3 in a third configuration.

FIG. 6 is a top view of the beam assembly of FIG. 1 with portions removed.

FIG. 7 is a perspective view of a partially exploded remote actuator assembly of the remote connection system of FIG. 1.

FIG. 8 is a schematic view of a method of operating the transportation system of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

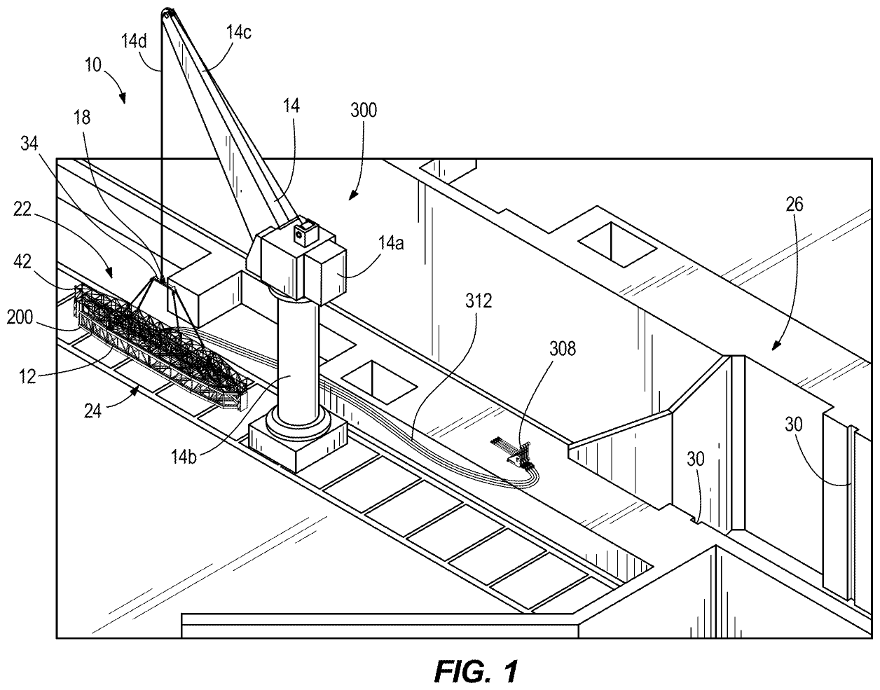

FIG. 1 illustrates a transportation system 10 for transporting a load 12, such as a bulkhead 200. The transportation system 10 includes a lifting machine 14 having a hook 18 for coupling to a beam assembly 22, and a remote connection system 300. In the illustrated embodiment, the lifting machine 14 is a crane and is specifically illustrated as a pedestal crane, including an operator's cab 14a supported on a pedestal 14b, a boom 14c extending from the operator's cab 14a, and a cable 14d supporting the hook 18. In other embodiments, the lifting machine 14 may include another type of crane, such as a portal crane. The beam assembly 22 couples the hook 18 to the load 12 for lifting and transporting the load 12. In the illustrated embodiment, the load 12 may be one or more of the bulkheads 200 that can be transported between a first location and a second location. In the illustrated embodiment, the bulkheads 200 may be transported between a storage area 24 and a usage area. The transportation system 10 may be used in a riverside environment, for example by a river lock 26. The river lock 26 may include a bulkhead slot 30 as the usage area. When positioned in the bulkhead slot 30, the bulkheads 200 may act as a dam to prevent fluid flow through the river lock 26.

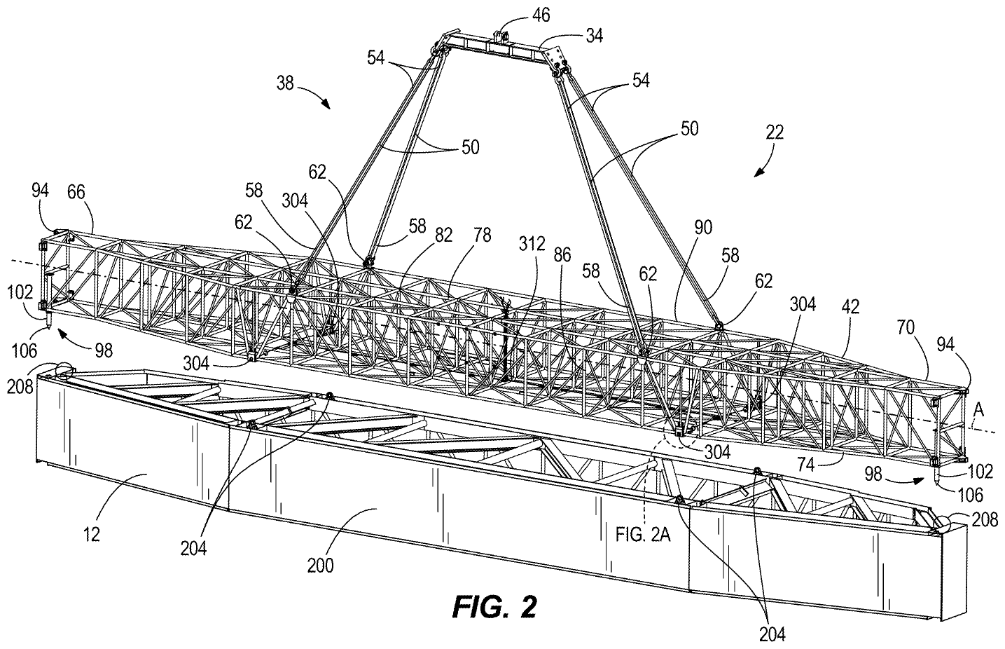

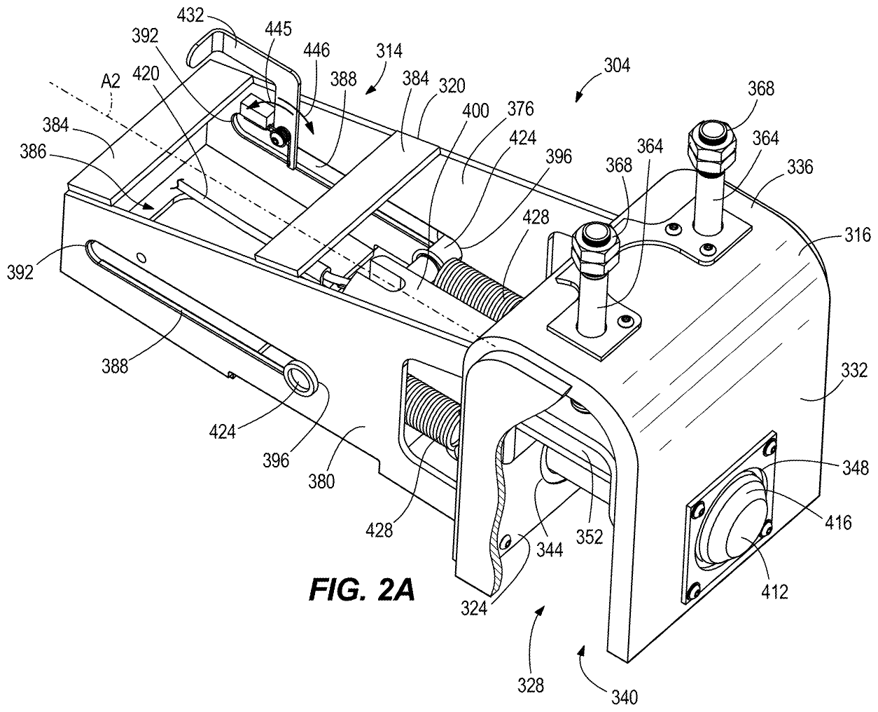

In the illustrated embodiment, the beam assembly 22 is coupled to the bulkhead 200 by the remote connection system 300. The remote connection system 300 includes a plurality of attachment mechanisms 304 (FIG. 2), positioned on the beam assembly 22. The attachment mechanisms 304 are connected to a remote actuator assembly 308 via a cable system 312. While the remote connection system 300 and transportation system 10 are described in the context of transporting the bulkheads 200 in and around a river lock 26, the remote connection system 300 and transportation system 10 may be used in any other environments where remote connection between a transportation system 10 and a load 12 would be advantageous.

Turning now to FIG. 2, the beam assembly 22 is shown in greater detail. The beam assembly 22 includes a hookup beam 34 (also referred to herein as an upper beam 34), a rigging system 38, and a spreader beam 42 (also referred to herein as a lower beam 42). The hookup beam 34 may include an opening 46 or another feature that receives the hook 18 of the crane 14 to couple the beam assembly 22 to the crane 14. The hookup beam 34 is coupled to the spreader beam 42 by the rigging system 38. The rigging system 38 includes one or more cables 50. The cables 50 may be formed of steel wires, polyester round slings, woven fibers, or other appropriate materials, or may be embodied as linked chains. The cables 50 each include a first end 54, which connects to the hookup beam 34, and a second end 58, which connects to a connection point or lug 62 on the spreader beam 42.

The spreader beam 42 includes rods forming a lattice structure extending along a longitudinal axis A between a first beam end 66 and a second beam end 70. The lattice structure allows the spreader beam 42 to remain light weight but strong enough to support the load 12. The spreader beam 42 includes a lower face 74 and an upper face 78 which extend parallel to the longitudinal axis A. The spreader beam 42 includes a central portion 82 located between the first beam end 66 and the second beam end 70. The central portion 82 includes a front face 86 and a rear face 90 that extend parallel to the longitudinal axis A. In the illustrated embodiment, the connection points 62 are positioned on the upper face 78. The illustrated beam assembly 22 includes four cables 50 and four connection points 62, with two adjacent the front face 86 and two adjacent the rear face 90. Other embodiments may include a different number of cables 50 and differently positioned connection points 62 as applicable.

With continued reference to FIG. 2, the spreader beam 42 includes bumpers 94 positioned at the first beam end 66 and the second beam end 70. The bumpers 94 may prevent damage to the environment, load 12, and spreader beam 42 in case of any collision during the transportation process. The attachment mechanisms 304 of the remote connection system 300 are supported on the spreader beam 42 adjacent the lower face 74. In the illustrated embodiment the remote connection system 300 includes four attachment mechanisms 304, however in other embodiments a different number of attachment mechanisms 304 may be used as is useful for the specific application. The four attachment mechanisms 304 are positioned on the central portion 82, with two adjacent the front face 86 and two adjacent the rear face 90. In the illustrated embodiment, the attachment mechanisms 304 are positioned longitudinally outward of the connection points 62. The attachment mechanisms 304 are positioned on the spreader beam 42 to align with a set of connector members or lugs 204 positioned on the bulkhead 200.

The spreader beam 42 also includes alignment features 98. In the illustrated embodiment, the alignment features 98 include rods 102 extending from the lower face 74 of the spreader beam 42. The rods 102 include a tapered end 106, which may be conically shaped. The tapered ends 106 guide the rods 102 into complementary receiving ports 208 positioned on the bulkhead 200. When the rods 102 are received by the receiving ports 208, the attachment mechanisms 304, positioned on the spreader beam 42, are aligned with the lugs 204.

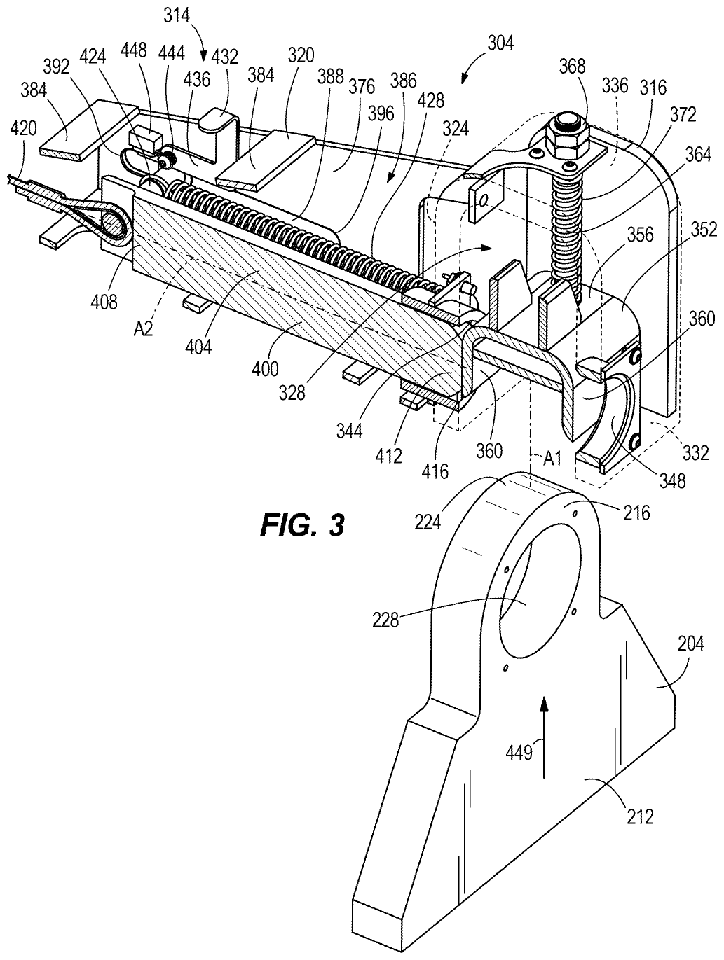

FIGS. 2A and 3-5 illustrate the attachment mechanisms 304 in more detail along with the lugs 204 of the bulkhead 200. In the illustrated embodiment, each attachment mechanism 304 is identical therefore only one is described in detail. However, in other embodiments, the attachment mechanisms 304 may be vary depending on the number of attachment mechanisms 304, the position or orientation of the mechanisms, or the type of load supported. FIG. 2A illustrates the fully assembled attachment mechanism 304 and FIGS. 3-5 are partial views of the attachment mechanism 304 in different configurations, with portions removed for clarity of discussion.

As shown in FIGS. 3-5, each lug 204 includes a lower portion 212 and an upper portion 216. The upper portion 216 includes a rounded outer surface 224 and a connector or pin receiving opening 228. The lower portion 212 is fixed to the bulkhead 200 and each upper portion 216 extends from the bulkhead 200 to be accessible by the attachment mechanism 304.

Referring back to FIG. 2A, each attachment mechanism 304 includes an actuator mechanism 314, a housing 316, and a bracket 320 extending from a first or front surface 324 of the housing 316. The housing 316 may be generally rectangular and defines a cavity 328. The housing 316 includes the front surface 324, a second or rear surface 332, a top surface 336, and a lower opening 340. The front surface 324 includes a first or front aperture 344 (FIG. 3) and the rear surface 332 includes a rear aperture 348 coaxially aligned with the front aperture 344. A plate 352 is slidably mounted in the cavity 328 for movement along a first axis A1 or insertion axis A1, extending from the lower opening 340 to the top surface 336.

The plate 352 (also referred to herein as the trip plate 352) includes a main plate 356 and two flanges 360 extending downward from edges of the main plate 356. The trip plate 352 is connected to a bolt 364 for slidably coupling to the housing 316, although in further embodiments more than one bolt 364 may be used. The bolt 364 extends through the top surface 336 of the housing 316 and includes a bolt head 368 positioned outside the cavity 328. A plate spring 372 surrounds the bolt 364 and is connected at one end to the main plate 356 and at the other end to the top surface 336.

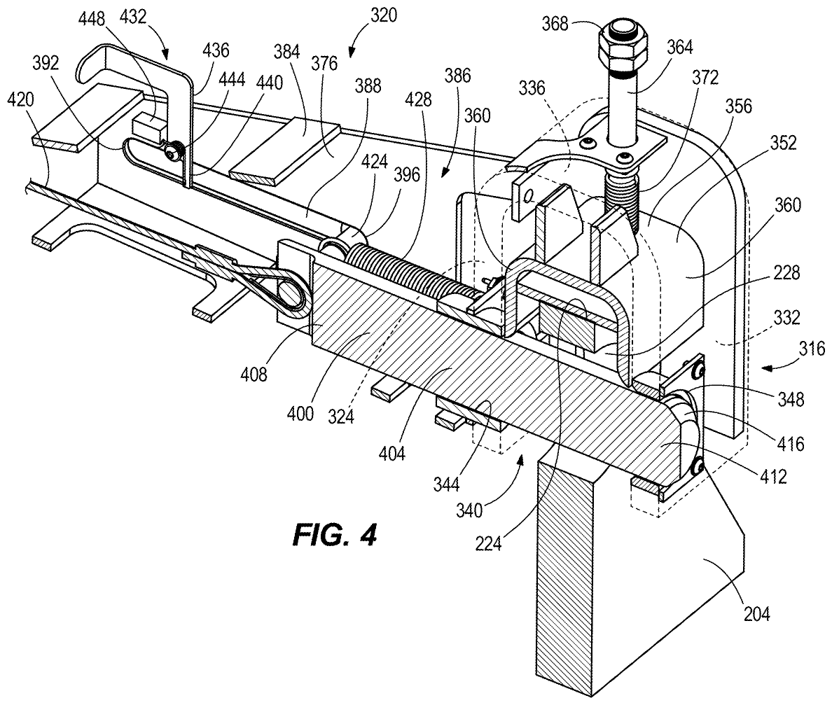

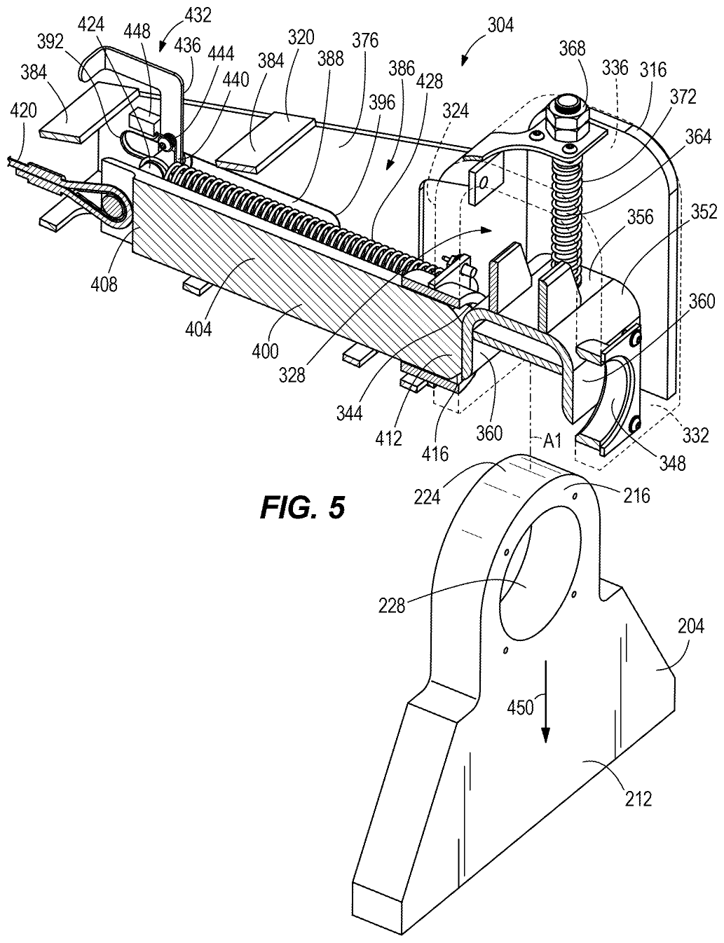

The trip plate 352 is movable between an upper position (FIG. 4) and a lower position (FIGS. 3 and 5). In the upper position, the bolt head 368 is spaced apart from the top surface 336 of the housing 316 and the main plate 356 is proximate the top surface 336 such that the flanges 360 do not obstruct the apertures 344, 348 and allow access to the cavity 328 via the apertures 344, 348. In the lower position, the main plate 356 is positioned further from the top surface 336 such that the flanges 360 obstruct the apertures 344, 348 and prevents access therethrough. The plate springs 372 may be compression springs, which bias the trip plate 352 toward the lower position.

The bracket 320 receives a lock member 400 (also referred to herein as the actuator pin 400) for locking the lug 204 to the spreader beam 42 via the attachment mechanism 304. The bracket 320 includes a first side plate 376 and a second side plate 380 connected by one or more cross bars 384 and extending generally parallel to each other. The bracket 320 defines a cavity 386 therebetween for receiving the actuator pin 400. A second axis A2 or pin axis A2, which is oriented perpendicularly to the first axis A1 in the illustrated embodiment, is defined by a longitudinal axis of the bracket 320. The actuator pin 400 is slidably supported within the cavity 386 for movement along the pin axis A2. Each of the first side plate 376 and the second side plate 380 include a guide slot 388 extending from a forward slot end 392 to a rear slot end 396. The guide slots 388 may also be referred to herein as elongated slots 388.

The actuator pin 400 includes a generally cylindrical body 404 with a first end 408 for connecting to the cable system 312 and a second end 412 including a chamfered edge 416. An extended line 420 of the cable system 312 connects between the first end 408 of the actuator pin 400 and the remote actuator assembly 308. The extended line 420 may also be referred to herein as the tug line 420. The actuator pin 400 includes a guide pin 424 passing through the cylindrical body 404 and extending from sides of the cylindrical body 404 located proximate the first end 408 in the illustrated embodiment. In some embodiments, rather than a single guide pin 424, the actuator pin 400 may include two separate guide pins 424 extending from the sides of the cylindrical body 404. Each guide pin 424 extends into one of the guide slots 388 and traverses the respective guide slot 388 between the forward slot end 392 and the rear slot end 396 such that the guide slot 388 defines the travel distance of the actuator pin 400. The actuator pin 400 is movable between an extended position (FIG. 4) and a retracted position (FIGS. 3 and 5). In the extended position, the actuator pin 400 is received in the front aperture 344, the cavity 328 of the housing 316 (including the pin receiving opening 228 of the lug 204 if positioned in the cavity 328), and the rear aperture 348. Further, the guide pins 424 travel in the guide slot 388 and are positioned near the rear slot end 396. In the retracted position, the actuator pin 400 is removed from at least the rear aperture 348 and the cavity 328 of the housing 316 (and thereby the lug 204 if positioned therein) and the guide pins 424 are positioned proximate the forward slot end 392 of the guide slot 388. The actuator pin 400 is further coupled to the housing 316 by pin springs 428 extending between the guide pins 424 and the front surface 324 of the housing 316. In the illustrated embodiment, the pin springs 428 are tension springs that bias the actuator pin 400 toward the extended position.

The bracket 320 further includes a locking latch 432 pivotally coupled to the first side plate 376 adjacent the guide slot 388, although in further embodiments, the locking latch 432 is coupled to another portion of the bracket 320, such as the second side plate 380 or cross bar 384). The locking latch 432 is movable between a locking position (FIG. 5) and a disengaged position (FIG. 3). The locking latch 432 includes an actuation end 436 that is accessible to a user and an engagement end 440. The engagement end 440 is shaped to selectively engage the actuator pin 400, and in particular in the illustrated embodiment one of the guide pins 424 at a certain point along the travel distance of the actuator pin 400. The locking latch 432 may be biased toward the locking position by a torsional spring 444. The locking latch 432 may rotate in a first direction 445 to move the locking latch 432 to the locking position, in which the engagement end 440 extends into the travel path of the guide pin 424 as it traverses the guide slot 388. The locking latch 432 can be rotated in a second direction 446 to move the locking latch 432 to the disengaged position in which the engagement end 440 is clear of the travel path of the guide pin 424 in the guide slot 388 and abuts a stop surface 448.

With specific reference to FIG. 3, the attachment mechanism 304 has a first configuration, also referred to as a default configuration. In the default configuration, the lug 204 may be spaced from the housing 316 and positioned outside the cavity 328. The trip plate 352 is biased by the plate springs 372 toward the lower position so that the flanges 360 are positioned adjacent to and obstruct the front and rear apertures 344, 348. The actuator pin 400 is in the retracted position and is biased by the pin springs 428 so that the rear end 412 with the chamfered edge 416 is positioned within the front aperture 344 and against the trip plate 352. The guide pins 424 are positioned adjacent the locking latch 432 and hold the locking latch 432 in the disengaged position such that the engagement end 440 contacts the stop surface 448. The lug 204 may travel relative to the attachment mechanism 304 along the insertion axis A1 in an insertion direction 449.

With specific reference to FIG. 4, the attachment mechanism 304 has a second configuration, also referred to as an active configuration. In the active configuration, the lug 204 is received into the cavity 328 through the lower opening 340. As the lug 204 enters the cavity 328, the outer surface 224 comes into contact with the main plate 356 of the trip plate 352 and overcomes the bias of the plate springs 372 to move the trip plate 352 to the upper position. The actuator pin 400 is biased by the pin springs 428 to the extended position and moves along the pin axis A2 until the guide pins 424 are positioned at the rear slot end 396 of the guide slot 388. The rear end 412 of the actuator pin 400 extends through cavity 328 and the rear aperture 348 of the housing 316 and may be visible to a user through the rear aperture 348, indicating to a user that the attachment mechanism 304 is in the active configuration. The cylindrical body 404 is received by the pin receiving opening 228 of the lugs 204. The locking latch 432 is biased by the torsional spring 444 to the locking position in which the engagement end 440 extends down toward the guide slot 388.

With specific reference to FIG. 5, the attachment mechanism 304 has a third or locked configuration in which the actuator pin 400 is held in the retracted position by the locking latch 432. In the locked configuration the actuator pin 400 is in the retracted position such that it is not received by the rear aperture 348 and the cavity 328 of the housing 316 and the guide pin 424 is positioned adjacent the forward slot end 392 of the guide slot 388. The locking latch 432 is in the locked position so that the engagement end 440 extends downwardly and contacts the guide pin 424 to prevent the actuator pin 400 from traveling along the pin axis A2 toward the housing 316. The actuation end 436 of the locking latch 432 contacts the stop surface 448 to prevent the locking latch 432 from rotating further and allowing the guide pin 424 to pass. The pin springs 428 are tensioned. Once the actuator pin 400 has been locked, the lug 204 can be removed from the cavity 328, allowing the plate springs 372 to bias the trip plate 352 to move to the lower position such that the plate springs 372 are at rest or lightly compressed. The flanges 360 are positioned to obstruct the front and rear apertures 344, 348.

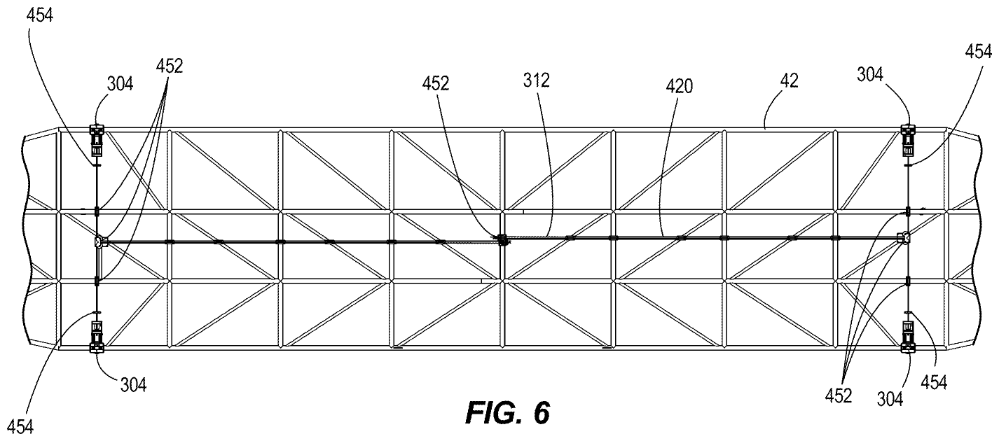

FIG. 6 illustrates the cable system 312 including the tug lines 420 in more detail. Each tug line 420 extends from the attachment mechanism 304 and is supported by a set of pulleys 452 that guide the tug lines 420 toward the center of the spreader beam 42. The tug lines 420 then extend through the open space in the environment to the remote actuator assembly 308, as shown in FIG. 1. Each of the tug lines 420 includes an associated grip 454 fixed to the tug line 420 adjacent the attachment mechanism 304. The grip 454 is movably coupled to the tug line 420 such that movement of the grip 454 is translated to the tug line 420.

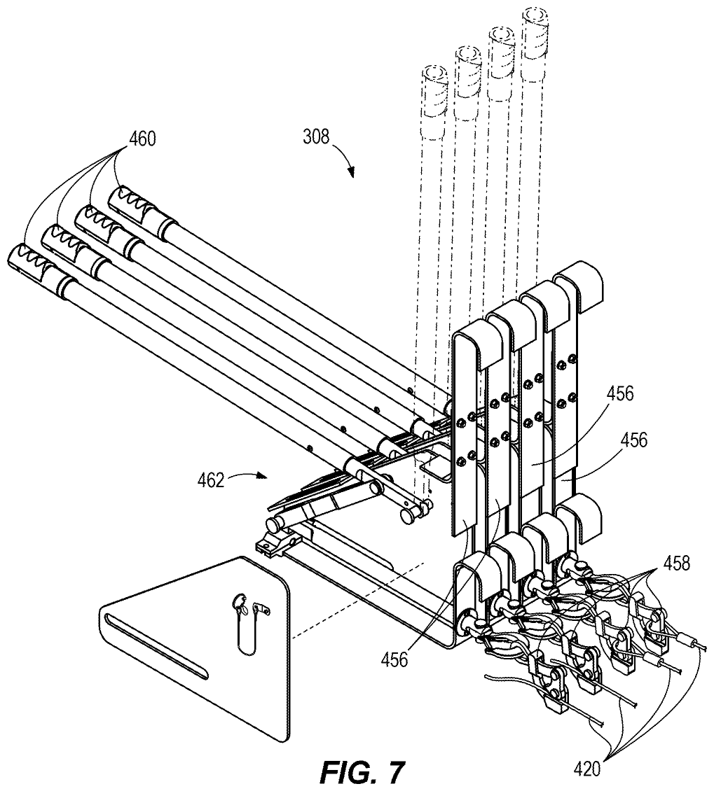

FIG. 7 illustrates the remote actuator assembly 308. Each tug line 420 connects to an associated remote actuator 456. Each remote actuator 456 (also referred to herein as the lever 456) includes a handle 460 movable between an activated position and an upright position (shown in phantom). Each tug line 420 may be coupled to an associated spool (not shown) which is used to wind the tug line 420 until it is taught. In some embodiments, the tug line 420 can be tightened by hand. Once the tug line 420 is pulled taught it is installed in a connector 458 of the remote actuator 456. In some embodiments the connector 458 is embodied as a clamp, and the tug line 420 is clamped between two jaws. In other embodiments, the connector 458 may be a lug or other tie off that allows either the end of the tug line 420 or a portion of the tug line 420 to be tied or looped into the connector 458. The remote actuator 456 includes a linkage system 462 that gives the handle 460 sufficient mechanical advantage to apply additional tension to the tug line 420 and therefore the connected actuator pin 400. The handle 460 moves the linkage system 462 to move the clamp 458 to a retracted position, applying tension to the tug line 420 and moving the connected actuator pin 400 to the retracted position. In the illustrated embodiment, the linkage system 462 may include the handle pivotally mounted about a fulcrum, a first link connected to the handle, and a second link connected between the first link and the connector 458. The second link may be constrained to move along an axis by an axial slot. In other embodiments other linkage systems may be used to apply tension to the tug line 420. The remote actuator assembly 308 may be bolted or otherwise mounted to a handrail (not shown) in the environment surrounding the river lock 26. Alternately, the remote actuator assembly 308 may be positioned in or adjacent the operators cab 14a of the crane 14 to allow for easy access by a crane operator.

In operation, the attachment mechanisms 304 may begin in the default position (FIG. 3). The crane 14 moves the beam assembly 22 adjacent the bulkheads 200 in the storage area 24 until the alignment features 98, or rods 102, of the spreader beam 42 align with the receiving ports 208 of the bulkhead 200. Once the rods 102 have been received by the receiving ports 208, the spreader beam 42 is moved toward the bulkhead 200 and the lugs 204 are moved toward the housing 316 of the respective attachment mechanism 304. As the lugs 204 are inserted in the insertion direction 449 along the insertion axis A1, shown in FIG. 3, the outer surface 224 contacts the main plate 356 of the trip plate 352 and compresses the plate springs 372, thereby moving the trip plate 352 along the insertion direction 449 to the upper position. As the trip plate 352 moves to the upper position, the flanges 360 move to unblock the front and rear apertures 344, 348. Without the flanges 360 obstructing the apertures 344, 348, the pin springs 428 bias the actuator pin 400 to the extended position. The flanges 360 engage the chamfered edge 416 of the rear end 412 of the actuator pin 400 as it moves through the cavity 328, the pin receiving opening 228 of the lug 204, and through the rear aperture 348. The guide pins 424 slide along the guide slot 388 until reaching the rear slot end 396. Therefore, the attachment mechanism 304 is then in the active configuration (FIG. 4) and the bulkhead 200 is coupled to the spreader beam 42 by the attachment mechanisms 304. The attachment mechanism 304 is moved from the default configuration to the active configuration by the lug 204 entering the cavity 328. Or, in other words, the beam assembly 22 is coupled to the load 12 automatically or without any operation on site of the attachment mechanism 304.

The crane 14 then moves the bulkhead 200 to a desired position, such as the bulkhead slot 30, where the bulkhead 200 is lowered into place. Once the bulkhead 200 is in place, the remote actuator assembly 308 is used to move the attachment mechanisms 304 from the active configuration to the locked configuration (FIG. 5). Specifically, the spools (not shown) are wound to tighten the tug line 420. The tug line 420 is then installed in the remote actuator 456 and each handle 460 is moved from the upright position to the activated position to pull the tug line 420. The tug line 420 is moved and guided by the pulleys 452 to move the actuator pin 400 from the extended position to the retracted position. The guide pins 424 are moved along the guide slot 388 toward the forward slot end 392 and move the locking latch 432 from the locked position to the disengaged position. Once the guide pin 424 passes the locking latch 432, the torsional spring 444 biases the locking latch 432 back to the locking position with the engagement end 440 blocking the return of the guide pin 424. The handle 460 can then be returned to the upright position and the tug line 420 is slackened such that the guide pin 424 comes to rest on the engagement end 440 of the locking latch 432. The tug line 420 can then be removed from the remote actuator 456, providing additional slack to the tug line 420 to allow the beam assembly 22 to be moved.

In the retracted position, the rear end 412 of the actuator pin 400 is removed from the cavity 328 and the lugs 204 are disconnected from the attachment mechanisms 304. Once the crane 14 lifts the spreader beam 42 away from the bulkhead 200, the lugs 204 to exit the cavity 328 along the insertion axis A1, in a removal direction 450, shown in FIG. 5. The removal direction 450 is opposite the insertion direction 449. As the lug 204 moves out of the housing 316, the trip plate 352 is biased back to the lower position by the plate springs 372. The locking latch 432 retains the actuator pin 400 spaced from the flanges 360 of the trip plate 352. The crane 14 then moves the beam assembly 22 to a location in the worksite that allows an operator access to the beam assembly 22. The operator uses the grip 454 to manually apply tension to the tug line 420 so that the guide pins 424 are moved to the forward slot end 392 of the guide slot 388. The locking latch 432 can then be manually moved to the disengaged position (FIG. 3) by the operator. The operator may use the actuation end 436 as a grip and hold the locking latch 432 in the disengaged position while the tug lines 420 are released, allowing the pin springs 428 to move the guide pins 424 past the locking latch 432 and the rear end 412 of the actuator pin 400 to rest against the flange 360 of the trip plate 352, thereby returning the attachment mechanisms 304 to the default position (FIG. 3). The locking latch 432 can then be released and is returned to the locked position by the torsional spring 444.

The operation can then be performed once more by moving a second bulkhead 200 from the storage area 24 to the bulkhead slot 30 or other locations at the worksite, including the storage area 24 or onto a transport vehicle. One advantage of the present embodiment is that the remote connection system 300 allows the beam assembly 22 to couple to and uncouple from the bulkhead 200 without personnel onsite in the storage area 24 or the bulkhead slot 30. Specifically, divers are not required to couple or uncouple the bulkhead 200 from the transportation system 10 when the bulkhead 200 is positioned underwater.

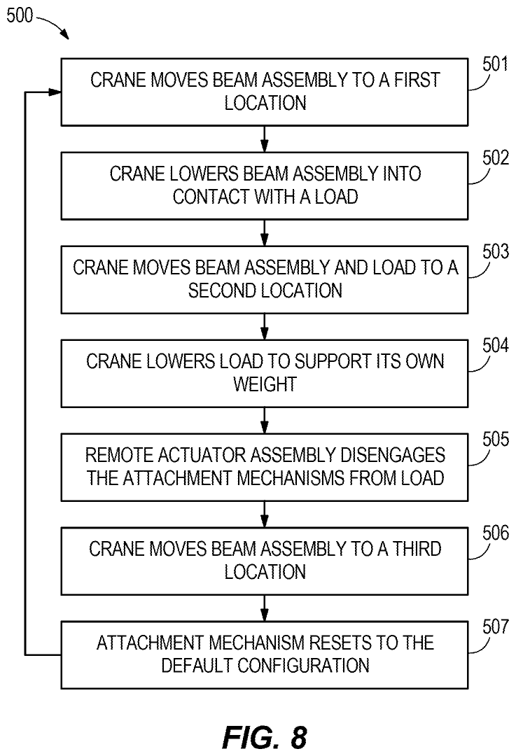

FIG. 8 illustrates a method 500 of operating the transportation system 10. The method 500 includes a step 501 including operating the crane 14 to move the beam assembly 22 to a first location. The first location may be the storage area 24 or may be the usage area or bulkhead slot 30. The beam assembly 22 may support the attachment mechanisms 304 in the default configuration (FIG. 3). Step 502 includes operating the crane 14 to lower the beam assembly 22 into contact with the load 12, which may be a bulkhead 200. As the crane 14 lowers the beam assembly 22 into contact with the bulkhead 200, step 502 further includes aligning the alignment features 98 with the receiving ports 208 such that the lugs 204 are aligned with the attachment mechanisms 304 and received therein to move each attachment mechanism 304 to the active configuration, as discussed above.

The method 500 further includes a step 503 including operating the crane 14 to move the beam assembly 22 and load 12 to a second location. The second location may be the storage area 24, the bulkhead slot 30, or other desired location. Next, in step 504 the crane 14 is operated to move the load 12 to support its own weight. If the second location is the storage area 24, the step 504 may include lowering the load 12 into contact with the ground or other support surface. If the second location is the bulkhead slot 30 or an underwater location, the step 504 may include lowering the load 12 into the bulkhead slot 30 until it contacts either the riverbed or another bulkhead 200.

The method 500 further includes a step 505 including operating the remote actuator assembly 308 to disengage the attachment mechanisms 304 from the load 12. In step 505 each remote actuator 456 may be operated to individually move each attachment mechanism 304 to the locked configuration. The step 505 may further include moving the handle 460 of each remote actuator 456 from the upright position to the activated position to thereby apply tension to the associated tug line 420. In step 505 the actuator pin 400 is moved from the extended position to the retracted position by operating the remote actuator 456. In step 505 the actuator pin 400 is moved past the retracted position such that the locking latch 432 moves to the locking position to prevent the actuator pin 400 from moving from the retracted position.

The method 500 further includes a step 506 in which the crane 14 is operated to move the beam assembly 22 to a third location. The third location may be adjacent the handrail or the remote actuator assembly 308 or may be another location where personnel are located. The step 506 may further include lifting the beam assembly 22 away from the load 12. In step 506, as the beam assembly 22 moves away from the load 12, the lug 204 is moved out of engagement from the trip plate 352, and the trip plate 352 is biased by the plate springs 372 into the lower position. In step 507, the attachment mechanism 304 is moved from the locked configuration to the default configuration. In step 507 tension is applied to the tug line 420 until the actuator pin 400 is moved toward the retracted position, such that the guide pins 424 are adjacent the forward slot end 392. In step 507, a user may grip the actuation end 436 of the locking latch 432 and move it downwards, toward the bracket 320, to rotate the locking latch 432 in the second direction 446, as shown in FIG. 2A. The engagement end 440 is thus moved out of the guide slot 388. The operator may release the tension in the tug line 420 such that the actuator pin 400 is free to travel toward the extended position until stopped by the trip plate 352. The steps 501-507 can be repeated as many times as necessary, varying the first and second locations as needed.

Although the invention has been described in detail with reference to certain preferred aspects, embodiments, and constructions, variations and modifications exist within the scope and spirit of one or more independent aspects of the invention as described.

What is claimed is:

1. An attachment mechanism configured to receive a connector member including a connector opening, the attachment mechanism comprising:
a housing defining a cavity configured to selectively receive the connector member;
an actuator mechanism including a lock member movable between an extended position, in which a portion of the lock member extends into the cavity, and a retracted position, in which the lock member is positioned outside the cavity; and
a plate movably mounted in the cavity and movable between a first position, in which the plate prevents the lock member from moving to the extended position, and a second position, in which the plate allows the lock member to move to the extended position;
wherein when the connector member is received in the cavity, the plate is moved from the first position to the second position and the lock member is at least partially received by the connector opening.

2. The attachment mechanism of claim 1, further comprising a bracket extending from the housing, and wherein the lock member is movably mounted in the bracket.

3. The attachment mechanism of claim 2, wherein the bracket includes at least one side plate including an elongated slot, wherein the lock member includes at least one guide pin, the guide pin configured to traverse the elongated slot.

4. The attachment mechanism of claim 3, further comprising a locking latch positioned adjacent the elongated slot, the locking latch configured to selectively prevent the guide pin from traversing the elongated slot.

5. The attachment mechanism of claim 1, further comprising a locking latch configured to selectively prevent the lock member from moving to the extended position.

6. The attachment mechanism of claim 5, wherein the attachment mechanism is movable to a first configuration, a second configuration, and a third configuration, wherein in the first configuration the plate is in the first position and the lock member is prevented from moving to the extended position, wherein in the second configuration, the plate is in the second position and the lock member is in the extended position, and wherein in the third configuration, the lock member is in the retracted position and the locking latch prevents the lock member from moving to the extended position.

7. The attachment mechanism of claim 1, wherein the plate is movable along a first axis, and the lock member is movable along a second axis perpendicular to the first axis.

8. The attachment mechanism of claim 1, wherein the lock member is biased toward the extended position and the plate is biased toward the first position.

9. The attachment mechanism of claim 1, wherein the actuator mechanism includes a remote actuator spaced from the housing, the remote actuator configured to move the lock member to the retracted position.

10. A remote connection system configured to remotely couple a beam assembly to a load, the load including a connector member with a connection opening, the remote connection system comprising:
an attachment mechanism coupled to the beam assembly for selectively receiving the connector member, the attachment mechanism including a lock member movable between a first position, in which the lock member is received in the connection opening, and a second position, in which the lock member is removed from the connection opening;
an extended line including a first end and a second end, the first end coupled to the lock member; and
a remote actuator coupled to the second end of the extended line for selectively applying tension to the extended line to move the lock member to the second position.

11. The remote connection system of claim 10, wherein the attachment mechanism includes a housing defining a cavity, the cavity selectively receiving the connector member, wherein the lock member is positioned at least partially in the cavity in the first position.

12. The remote connection system of claim 10, wherein the attachment mechanism includes a plate movable to selectively prevent the lock member from moving to the first position.

13. The remote connection system of claim 10, wherein the remote actuator includes a handle movable between an active position, in which tension is applied to the extended line, and an inactive position.

14. The remote connection system of claim 10, wherein the lock member is biased toward the first position.

15. The remote connection system of claim 10, wherein the attachment mechanism further includes a locking latch configured to selectively prevent the lock member from moving from the second position.

16. A transportation system for transporting a load comprising:
a lifting machine;
a beam assembly including an upper beam, a rigging, and a lower beam, the upper beam coupled to the lifting machine; and
a remote connection system including:
an attachment mechanism coupled to the lower beam, the attachment mechanism including a lock member movable to selectively engage the load to couple the beam assembly to the load for transportation; and
a remote actuator spaced from the beam assembly for operating the attachment mechanism.

17. The transportation system of claim 16, wherein the lifting machine is configured to move the beam assembly toward the load until the lock member automatically engages the load.

18. The transportation system of claim 16, wherein the actuator mechanism is movable between a first configuration in which the lock member engages the load and a second configuration in which the lock member is prevented from engaging the load.

19. The transportation system of claim 16, wherein the lock member is moved from the first configuration to the second configuration by the remote actuator.

20. The transportation system of claim 16, wherein the remote actuator is connected to the attachment mechanism by an extended line.
